(19) United States
(12) Patent Application Publication
(10) Pub. No.: US 2025/0350053 A1
(43) Pub. Date: Nov. 13, 2025

(54) CONNECTOR FOR ON-BOARD DEVICE

(71) Applicant: GKN Automotive Limited, Birmingham (GB)

(72) Inventors: Yuu Yaguchi, Tochigi (JP); Axel Schnitzler, Lohmar (DE)

(21) Appl. No.: 18/937,654

(22) Filed: Nov. 5, 2024

(30) Foreign Application Priority Data
May 10, 2024 (JP) JP2024-077045

(51) Int. Cl. H01R 12/72; B60R 16/023; H01R 12/70; H01R 13/502

(52) U.S. Cl. CPC H01R 12/722; B60R 16/0231; H01R 12/7088; H01R 13/502

(57) ABSTRACT

A connector for an on-board device is provided with: an input section including a power terminal and a bus terminal for receiving a binary signal; an output section including a driver terminal; a driver circuit for converting an electric power through the power terminal into a modulated power output to the driver terminal; a transceiver circuit for converting the binary signal to a digital signal; a control section for reading an operation instruction from the digital signal and controlling the driver circuit in accordance with the operation instruction; and a case so dimensioned as to support the input section and the output section, and accommodate the transceiver circuit, the driver circuit, and the control section.

### CROSS REFERENCE TO RELATED APPLICATIONS

This application is based upon and claims priority from Japanese Patent Application No. 2024-077045 filed on May 10, 2024, the entire contents of which are incorporated herein by reference.

### TECHNICAL FIELD

The disclosure herein relates to a connector for connecting an on-board solenoid-driven device with a control system for an automobile.

### BACKGROUND

An automobile utilizes various types of actuators such as electric motors. As each type requires specific circuits for power supply and control of the actuator, what type is selected and applied considerably influences design of an electric system for the automobile. In a case of a brush DC motor for example, it is only necessary to apply direct current on paired electrodes thereof, and its speed or output power control is often achieved by use of pulse current and modulation of its pulse width (so-called pulse width modulation: PMW). On the other hand, in a case of a brushless motor, use of three sets of alternating current with phase shifts by 120 degrees applied to three electrodes thereof and feedback control by Hall effect sensors or such are necessary.

Recent automobiles widely utilize programmable electronic control units (ECUs) for controlling respective on-board devices. A number of ECUs are connected to a network such as a controller area network (CAN) and mutually communicate therethrough to work in harmony. Incorporating the circuits for power supply and control in whether an ECU or an actuator is an issue affecting design of the entirety of the automobile. The art disclosed in JP 2018-98008 A relates to an example where an ECU, a power supply circuit and a control circuit are all incorporated in an actuator.

### SUMMARY

In a configuration where an ECU brings a power supply circuit and a control circuit, once specs of the ECU is determined, a type and a capacity of an actuator are necessarily determined depending on specs of the circuits incorporated in the ECU and therefore a posterior design change requires too much effort. In contrast in a configuration where the actuator brings these elements, the on-board control system may not be finally fixed before the specs of the actuator is determined. The connector as disclosed hereafter can mediate between the ECU and the actuator, thereby improving freedom of design.

According to an aspect, a connector to be connected to an on-board device driven by a solenoid with a sensor, is provided with: an input section including a power terminal to be connected to a power supply and a bus terminal to be connected to a controller area network; an output section including a driver terminal to be connected to the solenoid; a driver circuit connected to the power terminal and the driver terminal, the driver circuit configured to supply electric power for driving the solenoid to the driver terminal; a transceiver circuit connected to the bus terminal and configured to convert a change of a potential difference appearing at the bus terminal into a digital signal; a control section connected to the transceiver circuit and the driver circuit, the control section configured to read an operation instruction from the digital signal and control the driver circuit in accordance with the operation instruction; and a case having a first end and a second end distinct from the first end, the case being so dimensioned as to support the input section at the first end, support the output section at the second end, and accommodate the transceiver circuit, the driver circuit, and the control section.

### BRIEF DESCRIPTION OF THE DRAWINGS

The following detailed description of certain embodiments and best mode will be set forth with reference to the accompanying drawings, in which:

FIG. 1 is a schematic drawing illustrating an automobile with a plurality of ECUs mutually connected through a controller area network.

FIG. 2 is a schematic drawing illustrating a connection structure by which a plurality of actuators is connected to a single ECU.

FIG. 3 is a schematic perspective view of a connector according to an embodiment.

FIG. 4 is a block diagram of a main body of the connector.

FIG. 5 is a block diagram according to another embodiment.

FIG. 6 is a block diagram according to still another embodiment.

FIG. 7 is a chart describing conversion from a signal on a bus to a digital signal available to an internal controller.

### DETAILED DESCRIPTION

Exemplary embodiments will be described hereinafter with reference to the appended drawings. Drawings are not necessarily made to scale and therefore it is particularly noted that dimensional relations are not limited to those drawn therein.

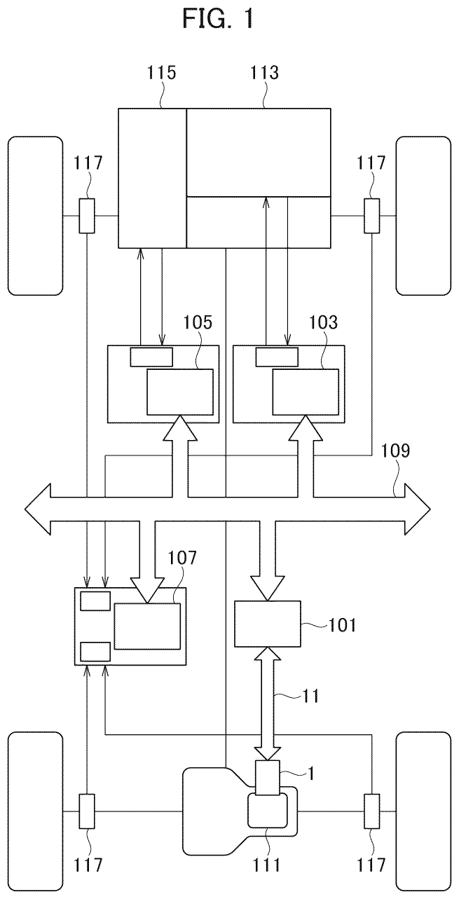

Referring mainly to FIG. 1, a connector 1 according to the present embodiment is used for connecting an on-board actuator 111 to an electronic control unit (ECU) 101 on board the automobile. The automobile is provided with a power source 113 including either or both of an engine and an electric motor, and a gear system including a transmission 115 for transmitting torque from the power source to axles. When taking a four-wheel drive car as an example, the torque generated by the power source 113 is distributed to front wheels and is partly extracted and transmitted through a propeller shaft to the rear part of the car, where a differential distributes the extracted torque to a right rear wheel and a left rear wheel. The differential often includes a device for limiting differential motion, which the actuator 111 is used to drive. An example of the actuator 111 is an electric motor or solenoid actuator, which is anyway electromagnetically driven by a solenoid. In addition, the automobile is provided with a plurality of programmable ECUs for controlling functions of its components. In the example shown in FIG. 1, the ECU 101 controls the actuator 111 in the differential, the ECU 103 controls the power source 113, and the ECU 105 controls the transmission 115, respectively, and as well the automobile is provided with various sensors for use in control executed by the ECUs and the ECU 107 is connected to these sensors and collects signals therefrom. FIG. 1 illustrates angular velocity sensors provided respectively on the axles as an example. The ECUs 101-107 are mutually connected through a bus 109 compliant to a controller area network (CAN) standard for example. Needless to say, this is merely an example for convenience of explanation. Thus the automobile may be front-engine/front-wheel (FF) driven, front-engine/rear-wheel (FR) driven or driven by any other type, and may be provided with other sensors, devices and ECUs.

According to the present embodiment, not the ECU 101 but instead the connector 1 is provided with a control circuit for directly controlling the actuator 111. The ECU 101 uses a bus 11 to communicate with the control circuit and thereby controls the actuator 111 indirectly. The bus 11 may be also compliant to the CAN standard and constitute a part of the bus 109 or an independent bus from the bus 109.

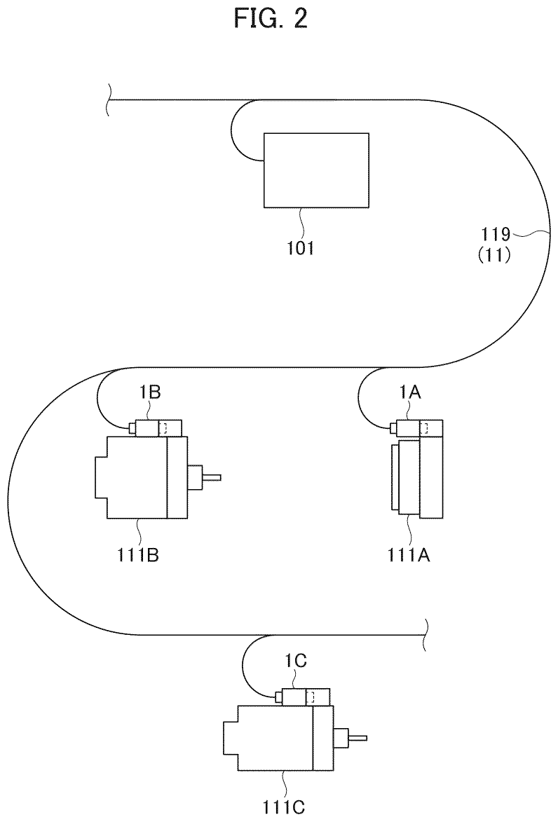

The CAN bus 11 is, for example, physically made up of a twisted pair cable of an H-wire and an L-wire. Referring to FIG. 2 in combination with FIG. 1, a wire harness 119 including a power line, a ground line and any other lines as well as the pair cable may be used to electrically connect the ECU 101 with the actuator. Although FIG. 2 merely shows a connection in a form of a linear bus, a star form or any other form is possible. The connection is not limited to a one-by-one form, but the number of connected nodes can be arbitrarily increased or decreased as branches can be readily made on these lines. In the present embodiment, connectors 1A, 1B, 1C, . . . respectively execute control about actuators 111A, 111B, 111C, . . . The ECU 101 does not directly execute control but simply bears a load about issuance of control instructions to the connectors 1A, 1B, 1C, . . . , thereby facilitating construction of a system with such a connection. In addition, as will be described in more detail, differences in ways for driving the actuators do not affect the algorithm for operating the ECU 101 because the connectors 1A, 1B, 1C, . . . absorb the differences. That is, the actuators 111A, 111B, 111C, . . . can be compatibly connected to the ECU 101 however the types of these actuators vary.

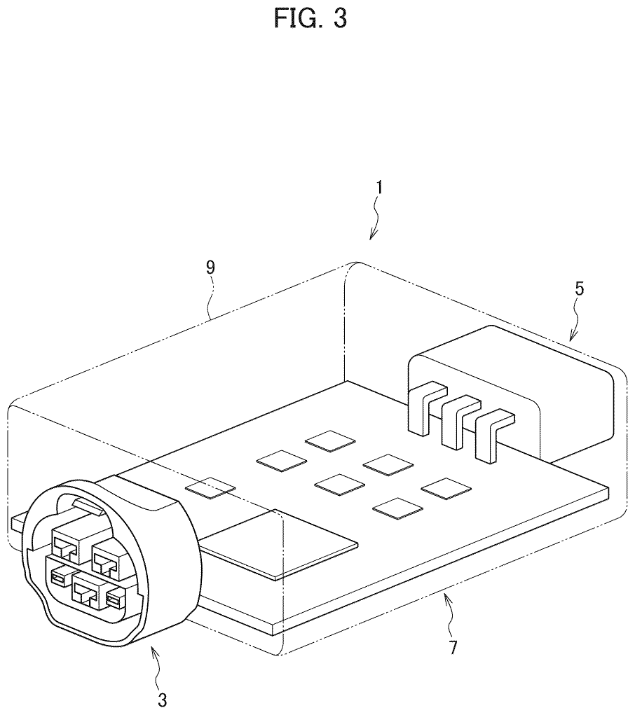

Referring mainly to FIG. 3, the connector 1 is provided with an input section 3 for connecting with the wire harness 119, an output section 5 for connecting with the actuator 111, a body section 7 including a control circuit and others, and a case 9 so dimensioned as to accommodate at least the body section 7. The case 9, although not necessarily, supports the input section 3 at its one end and the output section 5 at another end. The input section 3 may be in the form of a socket adapted to receive a plug led from the wire harness 119, and the output section 5 may be in the form of a plug adapted to directly plug into a socket of the actuator. From the input section 3, nonetheless, some or all of the lines may be not via the socket but directly led out. In any case, the connector 1 is independent of both the ECU 101 and the actuator 111 and is connectable to and removable from both these devices.

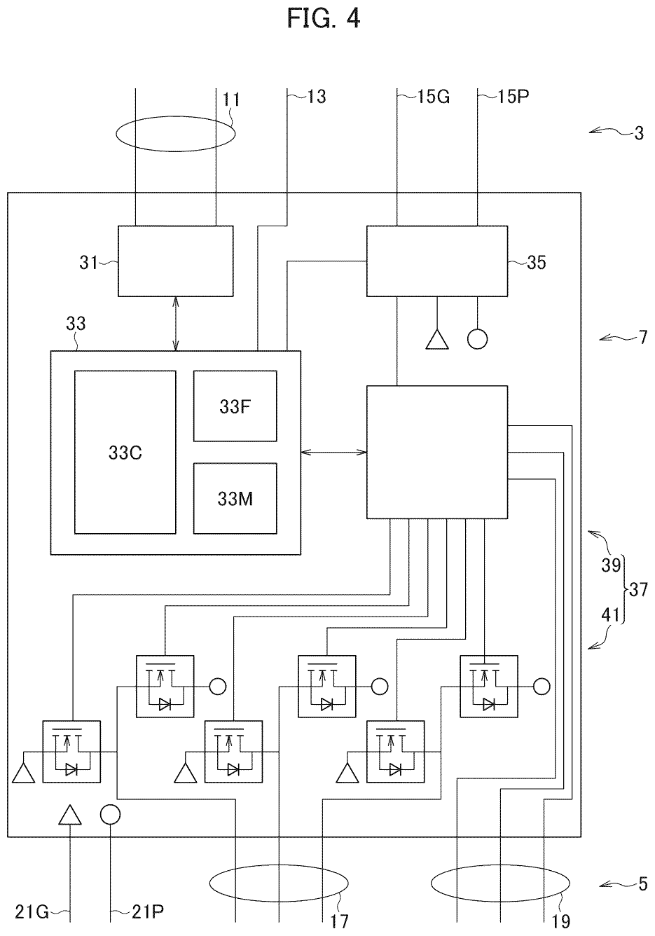

Referring to FIGS. 4 through 6 in combination with FIG. 3, the input section 3 may have a common structure independent of the type of the actuator 111. Specifically, the input section 3 is at least provided with a pair of terminals to be connected to the bus 11, a power terminal 15P and a ground terminal 15G, and may include an ignition terminal 13 or one or more other terminals as well. The ground terminal 15 is electrically grounded and thereby kept at the ground potential, and the power terminal 15P is subject to a power-supply potential of +12 V for example relative to the ground potential, so as to receive electric power from the power supply. To the ignition terminal 13 applied is a signal representing whether the power source 113 is ON or OFF. For example, the ground potential (0 V) appears there at a time of OFF and the power potential (+12 V) appears there at a time of ON.

The body section 7 is at least provided with a transceiver circuit 31 for communication through the bus 11, a control section 33, a power circuit 35 for supplying electric power to the body section 7 and the actuator 111, and any of driver circuits 37, 43, 55. Which of the driver circuits 37, 43, 55 is used depends on the type of the actuator 111 to be connected. These elements may be mounted on a single printed board and the input section 3 and the output section 5 are secured to the same printed board.

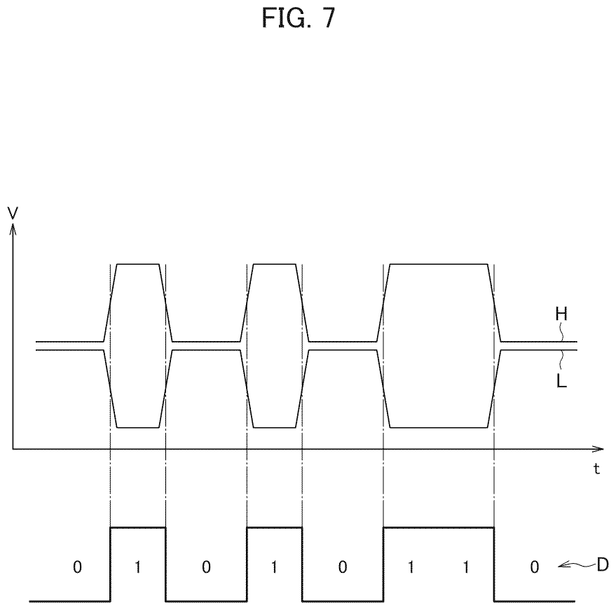

The transceiver circuit 31 is connected to the bus terminals connected to the bus 11 and is, through the internal bus, connected to the control section 33, thereby mediating communication between the bus 11 and the control section 33. On the H-wire and the L-wire, potential differences such as those shown in FIG. 7 for example appear, and the transceiver circuit 31 converts the potential differences into a digital signal D as shown in the lower part of the same chart and outputs it to the control section 33. Needless to say, the transceiver circuit 31 is further capable of converting a digital signal output from the control section 33 into potential differences and outputting to the bus terminals.

The control section 33 is connected to the transceiver circuit 31 through the internal bus and is further connected to any of the driver circuits 37, 43, 55. The control section 33 reads operation instructions by the ECU 101 out of the converted digital signal D, and controls the driver circuit 37, 43 or 55 in accordance with the operation instructions. To the control section 33 applicable is a specially designed hardware adapted to implement the control as instructed, but instead a programmable micro control unit (MCU) can be used.

The MCU typically includes a central processing unit (CPU) 33C, a temporary storage memory 33M such as a random access memory and a flash memory 33F. Any well-known general-purpose CPU is applicable to the CPU 33C, and an example thereof is, but not limited to, one commercially available under the name of ARM CORTEX-M (registered trademark(s) of Arm Limited). The flash memory 33F stores a firmware for booting the CPU 33C and its peripheral devices and can additionally store parameters and/or programs required to operate the driver circuit 37, 43 or 55, thereby the ECU 101 operate the CPU 33C as a means for controlling the driver circuit 37, 43 or 55. As will be readily understood, the MCU is not required to contain a special algorithm for achieving any special function but is merely required to have abilities of receiving, storing and processing instructions from the ECU 101. The MCU is, of course, not excluded to contain any special algorithm so as to achieve any additional function.

When a driver operates a switch, key or dial at hand to instruct the system to lock differential motion in the differential for example, the ECU 101 receives the instruction directly or through the bus 109 and issues a corresponding operation instruction to the control section 33 so as to lock the differential in accordance with its own algorithm. The control section 33 in response receives and reads the operation instruction through the bus 11 and simply follows the operation instruction or additionally refers the stored parameters/programs to cause the driver circuit 37, 43 or 55 to generate driving current, thereby operating the actuator 111 to lock the differential. More specifically, the control section 33 writes parameters required to start actions to a register of the driver circuit 37, 43 or 55 according to the operation instruction and, after a time also specified by the operation instruction, rewrite the content of the register to stop the actions.

The power circuit 35 converts a voltage applied to the power terminal 15 into voltages respectively suitable for the devices and thus supplies electric power thereto. In addition to such voltage conversion, it may have a function of noise reduction. The control section 33 and the driver circuit 37, 43 or 55 receives the electric power through connections to the power circuit 35 and the ground terminal, and as well the power circuit 35 may also output electric power to the actuator 111 through terminals 21P, 21G.

Each driver circuit 37, 43, 55 is generally composed of a gate driver 39, 45 or 57 and a bridge circuit 41, 45 or 59. The bridge circuit 41, 45 or 59 is for example a circuitry with bridge connections made up of switching devices such as insulated gate bipolar transistors switched on/off by gate signals applied by the gate driver 39, 45 or 57. Patterns for switching on/off are specified by flag bits momently rewritten in the register in the gate driver 39, 45 or 57. Structural details of the driver circuit, however, depend on the type of the actuator 111 and will be described below in more detail.

An example of the driver circuit 37 adapted to drive a brushless DC motor applied to the actuator 111 will be described hereinafter with reference to FIG. 4. The driver circuit 37 includes the gate driver 39 and a so-called B6 bridge circuit 41. The gate driver 39 receives outputs from Hall effect sensors for measuring a rotor's position relative to solenoids in the motor to carry out feedback control and, under the feedback control, switches on/off the respective switching devices in the B6 bridge circuit 41. Any well-known circuit configured for this purpose, or a chip (or system-on-chip) integrating such a circuit and the MCU described above, is applicable. Such a chip is commercially available under the name of Infineon MOTIX (registered trademark(s) of Infineon Technologies AG) but is not limited thereto. The B6 bridge circuit is composed of three sets of half bridge circuits, each of which is composed of a pair of n-channel MOSFETs, for example, and each half bridge circuit is connected to the power circuit 35 and outputs a pulse current to a U, V or W pole of the motor. Respective gates thereof are connected to the gate driver 39 for current control and thereby the bridge circuit 41 outputs three-phase currents to drive the motor.

The output section 5 includes driver terminals 17 and sensor terminals 19, and may further includes a power terminal 21P and a ground terminal 21G for supplying electric power to the Hall effect sensors or any other supplementary devices. The driver terminals 17 include three sets of terminals respectively connected to the three half bridge circuits. The sensor terminals include three terminals respectively connected to the three Hall effect sensors and feed back potential changes appearing in the terminals to the gate driver. The terminals 21P, 21G may be directly connected, or pass through the power circuit 35, to the terminals 15P, 15G. The output section 5 may be further provided with additional terminals for detecting any status of the motor. In any case, the output section 5 may be structured in a shape imitating a plug having a configuration adapted for a socket of the brushless DC motor. As the plug and the socket are widely used, this configuration is advantageous in light of compatibility.

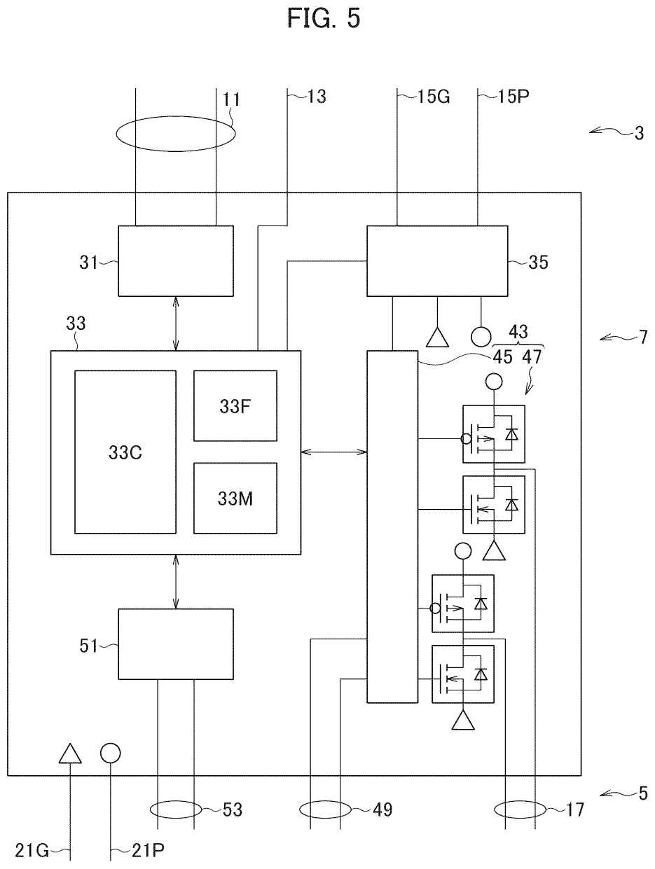

Referring to FIG. 5, in a case where the actuator 111 is a brushed motor, the driver circuit 43 is merely required to controllably output direct current and therefore driver terminals 17 are provided in pair. The output through the driver terminals 17 may be, most elementarily, voltage-controlled or current-controlled direct current but width-modulated pulse current for example is usable for improved controllability of the motor. The gate driver 45 is a circuit capable of carrying out pulse width modulation (PWM) control and, by connecting a so-called H-bridge circuit 47 composed of two sets of half bridges for example therewith, carries out the PWM control of the motor. As well as the terminals 17, 21P and 21G, the output section 5 may be further provided with sensor terminals 49 for connecting with an encoder for measuring rotation speed of the motor. Signals received through the sensor terminals 49 are used for feedback control of the pulse width modulation. The motor may, although not essential, have additional sensors such as a temperature sensor and accordingly the output section 5 may be provided with additional terminals 53. The body section 7 may be provided with a converter 51 for converting the sensor outputs into digital signals and the converter 51 is connected to the additional terminals 53 and the control section 33. The output section 5 can be, also in this case, in the form of a plug adapted to directly plug into a socket of the motor, thereby providing compatibility with the conventional configurations.

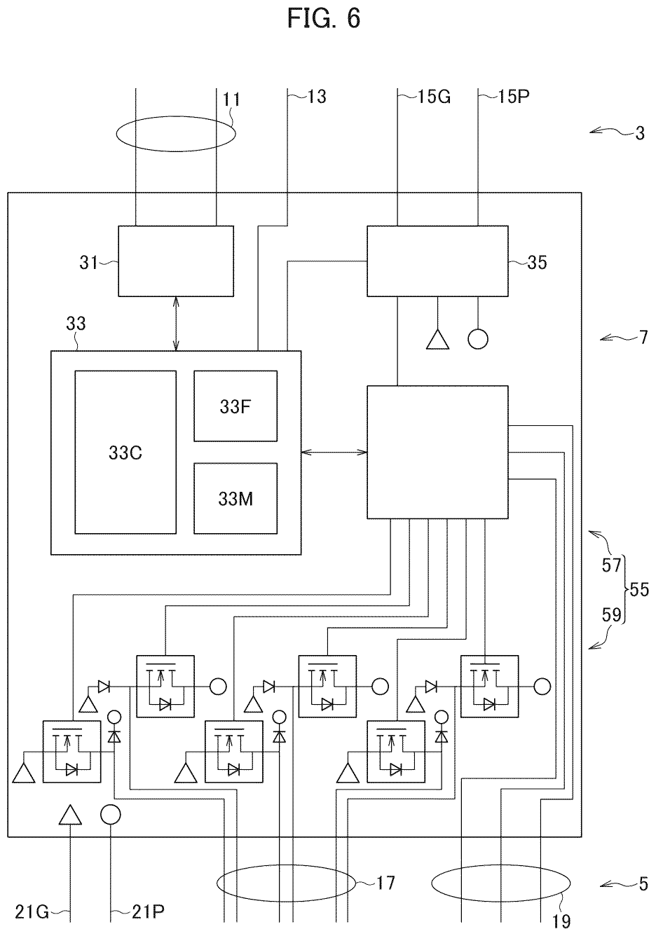

Referring to FIG. 6, in a case where the actuator 111 is a switched reluctance motor, the driver circuit 55 is for example composed of a so-called asymmetric H-bridge circuit 59 and a gate driver 57 therefor. If the motor has six stator poles and four rotor poles, the asymmetric H-bridge circuit is composed of three sets of switching device pairs. Respectively from these pairs, paired lines corresponding to the stator poles are led out and therefore the driver terminals 17 are composed of six terminals. The sensor terminals 19 include three pairs of terminals respectively connected to three sets of Hall effect sensors and also connected to the gate driver 57. The gate driver 57, in response to outputs from the Hall effect sensors, switches on/off the switching devices, thereby controlling rotation of the SR motor. The number of the pairs of the switching devices and the number of the driver terminals 17 and the sensor terminals 19, however, both depend on the number of the stators. As with the case described above, the SR motor may have additional sensors and accordingly the output section 5 may be provided with additional terminals, although not shown in the drawing. The output section 5 can be, also in this case, in the form of a plug adapted to directly plug into a socket of the motor, thereby providing compatibility with the conventional configurations.

Although the above descriptions merely exemplify the brushless DC motor, the brushed motor and the SR motor, needless to say, the actuator 111 is not limited to these examples. Any embodiments with simpler actuators such as a solenoid actuator or any device rather requiring complex control such as the power source 113 or a regenerative brake are possible. While configurations of the driver circuit and the output terminals may be changed depending on the subject of control, the input section 3 can be a common configuration in either case. As the connector 1 absorbs differences originated from the types of the actuators, the on-board ECU 101 is not required to have a special hardware specific to the subject of control and is naturally not required to have a software for operating the hardware. The ECU 101 is only required to have a software for executing steps for control. As the present embodiments reduce the load, the ECU 101 can bear another operation in place of direct control of the actuator or it is readily embodied that one ECU 101 controls a plurality of actuators. In addition, the control section 33 has an inherent capacity to execute operations and can therefore bear a part of operations of the ECU. These features are beneficial in increasing freedom of automobile design. The output section 5 can be formed as a configuration adapted for conventional actuators and in turn the actuators are not required to have special configurations, thereby providing compatibility with the conventional configurations.

Although certain exemplary embodiments are described above, modifications and variations of the embodiments will occur to those skilled in the art, in light of the above teachings.

What is claimed is:

1. A connector to be connected to an on-board device driven by a solenoid with a sensor, comprising:
an input section including a power terminal to be connected to a power supply and a bus terminal to be connected to a controller area network;
an output section including a driver terminal to be connected to the solenoid;
a driver circuit connected to the power terminal and the driver terminal, the driver circuit configured to supply electric power for driving the solenoid to the driver terminal;
a transceiver circuit connected to the bus terminal and configured to convert a change of a potential difference appearing at the bus terminal into a digital signal;
a control section connected to the transceiver circuit and the driver circuit, the control section configured to read an operation instruction from the digital signal and control the driver circuit in accordance with the operation instruction; and
a case having a first end and a second end distinct from the first end, the case being so dimensioned as to support the input section at the first end, support the output section at the second end, and accommodate the transceiver circuit, the driver circuit, and the control section.

2. The connector of claim 1, further comprising:
a sensor terminal to be electrically connected to the sensor.

3. The connector of claim 2, wherein the driver circuit is configured to modulate the electric power in accordance with a change of a potential difference appearing at the sensor terminal.

4. The connector of claim 1, wherein the power terminal includes a positive terminal and a ground terminal, and the bus terminal includes an H-terminal and an L-terminal.
